(19) United States
(12) Patent Application Publication
(10) Pub. No.: US 2006/0213979 A1
(43) Pub. Date: Sep. 28, 2006

(54) Method and system of detecting fraud and incremental commitment of value

(75) Inventors: Glenn Earle Geller, Las Vegas, NV (US); Lyann Nguyen, Las Vegas, NV (US); Michael Joseph Crook, Las Vegas, NV (US)

Correspondence Address: HAYNES BEFFEL & WOLFELD LLP, P O BOX 366, HALF MOON BAY, CA, 94019, US

(73) Assignee: bluko Information Group, Las Vegas, NV (US)

(21) Appl. No.: 11/365,138

(22) Filed: Mar. 1, 2006

Related U.S. Application Data
(60) Provisional application No. 60/665,403, filed on Mar. 25, 2005.

(51) Int. Cl. G06K 5/00; G06Q 40/00

(52) U.S. Cl. 235/380; 705/39

(57) ABSTRACT

The present invention relates to stored value cards and improved bank processing systems. In particular, it relates to systems and methods that load value into demand deposit and plastic account number accounts corresponding to the stored value card and make funds available without delay, even for the unbanked. It also relates to methods for avoiding fraud.

### PRIORITY CLAIM AND RELATED APPLICATIONS

This application claims the benefit of U.S. Provisional application No. 60/665,403 filed on Mar. 25, 2005. For convenient reference, the provisional application is entitled “Stored Value Card/Demand Deposit Account System, Method And Device”.

This application is related to other applications filed contemporaneously. The related applications are entitled “Method and System of Advancing Value from Credit Card Account for Use with Stored Value Account”, “Method and System of Detecting Cash Deposits and Attributing Value”, and “Method and System of Detecting Fraud and Incremental Commitment of Value”. The related applications are filed in the names of inventors Glenn Geller, Lyann Nguyen and Michael Crook.

### BACKGROUND OF THE INVENTION

The present invention relates to stored value cards and improved bank processing systems. In particular, it relates to systems and methods that load value into demand deposit and plastic account number accounts corresponding to the stored value card and make funds available without delay, even for the unbanked. It also relates to methods for avoiding fraud.

The banking industry engages in many practices that give banks the advantage of the float and reduce customers' or consumers' access to their funds. An ordinary consumer may experience delays in funds availability as long or longer today than they were a decade ago, before sophisticated automation projects. For instance, a bank that receives a large deposit via an ATM may hold the depositor's money for 10-14 days, even if the deposit was a check from a local bank that participates in overnight clearing with the recipient bank.

The banking industry's slow motion negotiation of transferred value is motivated to capture the float and necessitated by banking systems end-of-day closings. For instance, a 3 p.m. cut-off may apply to deposits, so that deposits made later in the day are treated as if they were made the following day. An early cut-off gives the bank extra time to prepare for end-of-day closings and evening or overnight batch procedures.

The automated clearing house (ACH) procedure is one example of a banking system designed for overnight batch processing. While transactions are tracked through the day and a positive balance file is accumulated for a particular account, ACH transactions are reconciled and processed overnight. Similarly, positive balance files are applied to an account overnight.

In general, the banking industry is encumbered by overnight processing cycles and extended holds on funds. The banking industry avoids charging per transaction fees on demand and credit card accounts, by using the float to finance operations. This economic model motivates the banks to reinforce the overnight processing model and not to consider making funds available instantly.

In the face of banking intransigence, many so-called “unbanked” consumers use payroll-cashing services that charge substantial fees. The unbanked also pay substantial fees to services such as Western Union, in order to send money overseas to family and loved ones. Some estimates place the unbanked population of the United States at more than 40 million adults. Some of the unbanked are considered undesirable customers; others do not want to participate in required banking authentication procedures; yet others do not have enough money to maintain a qualifying balance.

The credit card authorization and settlement system for bank customers is based on performing a real-time authorization against an available balance, but delayed physical posting of the completed transaction. Transfer of funds to settle an account is delayed by as little as one business day and as long as three business days. Transactions are processed, settled and funds transferred in batches as opposed to immediately as individual transactions. Thus, credit card systems are not totally in real-time and funds cannot be moved from one account to another instantly. Immediate transfer of value from a credit card to a debit card account has not been a feature of credit card systems.

The ATM or PIN-based debit card authorization and settlement system is based on face-to-face contact between the cardholder and a merchant or a physical ATM machine. PIN-based debit cart systems do effect immediate authorization and, under some limited situations such as within the same bank, can affect immediate transfer of funds between accounts. Between banks, settlement of debit card transactions is processed in batches over night. However, PIN-based debit cards do not allow the cardholder to use a telephone or the Internet for transactions, because the system requires the physical presence of the plastic bank card and the physical entry of a PIN code. Allowing for immediate transfer of value without the physical presence of the cardholder at a machine or merchant is not supported by PIN-based debit cards.

CashAnywhere presented another alternative, a card-less non-bank system using virtual accounts. CashAnywhere addressed e-commerce merchant payments using virtual accounts taht did not link a consumer to any bank demand accounts. Some of the participating merchants did not qualify to participate in credit card processing, due to the high risk related to their Internet or telephone-based activities. Some of the participating customers were unwilling to disclose their identities or banking information, and used CashAnywhere for anonymous payments or to reduce the chance of identity theft or misuse of personal information by anonymous vendors. A merchant who supported CashAnywhere payments provided a link on their web site. A consumer could open and use a CashAnywhere virtual account and load value to the account from credit cards or checking accounts. These were “virtual accounts” in the sense that they were held in a pooled commercial account owned by CashAnywhere. The virtual account had a unique ID number that the system operator used for accounting. The consumer could draw on value that had been transferred to their virtual account using the unique ID provided. CashAnywhere was unable to verify that checking account numbers given by consumers were valid or adequately funded to satisfy the transfer. CashAnywhere experienced a significant lag between consumer authorization to CashAnywhere (including fraudulent authorizations) and when CashAnywhere could reliably obtain funds. For instance, CashAnywhere was required to maintain large rolling reserves (five percent for seven months) to pay off charge-backs or fraud reversals assessed by banks that processed their credit card advances. This led to merchant fees on the order of eight percent. CashAnywhere could not restrain the consumer's spending for long enough to avoid the risk of fraud. A consumer who signed up and authorized a transfer expected to be able to make an online or telephone purchase immediately. CashAnywhere had limited consumer acceptance because a non-banking system has limited acceptance by merchants and no immediate access to cash withdrawal from the virtual account. Eventually, CashAnywhere failed under the weight of fraudulent consumer activity.

CalNet Business Bank in Sacramento, Calif. creatively marketed bank account based services. CalNet offered debit cards that marketers could rebrand and combine with software developed by Your Bank On Line (YBOL). CalNet's system was a bank account-based. In cooperation with eFunds, CalNet provided PIN-based debit card access to bank accounts. PIN-based debit cards cannot be used for Internet or telephone transactions, because the supporting systems, such as Cirrus, require physical card presentment and physical encryption of the entered PIN, prior to transmission for authorization. CalNet withdrew from providing rebranded debit card services in 2005.

An opportunity arises to meet the needs of the unbanked with a rapid-turnaround, real time system that is fee-based, instead of float-based. Real time banking systems can be introduced that make funds available in seconds or minutes, instead of days. Integrated real time banking can reduce the cost of processing, with expected savings to consumers, whether unbanked or just interested in improved banking services.

### SUMMARY OF THE INVENTION

The present invention relates to stored value cards and improved bank processing systems. In particular, it relates to systems and methods that load value into demand deposit and plastic account number accounts corresponding to the stored value card and make funds available without delay, even for the unbanked. It also relates to methods for avoiding fraud. Particular aspects of the present invention are described in the claims, specification and drawings.

### BRIEF DESCRIPTION OF THE DRAWINGS

FIG. 1 illustrates a number of computer implemented services and databases interacting, with physical changes to the recorded account balances stored in the databases.

FIG. 2 depicts some processing functions and some accounts, organized by party.

FIG. 3 is a high-level block diagram of loading value from a consumer's credit card into a demand deposit account.

FIG. 4 is a high-level block diagram of processing a cash deposit in multiple parts with a bank teller.

FIG. 5 is a high-level block diagram of a consumer adding value to a demand deposit account.

FIG. 6 is a high-level block diagram, omitting authorization steps, of redemption of value from a stored value card.

FIG. 7 illustrates an authorization process that may be applied to telephone calls or online merchants.

FIGS. 8-9 depict summary and history information for one or more accounts, which may be PAN or DDA accounts.

FIG. 10 depicts adding an account with a PIN as an additional authentication factor to a user's stored value card.

FIGS. 11-17 depict adding value to an SVC and related accounts from a credit card, checking account or cash deposit.

FIGS. 18-20 depict redeeming value by transferring it from an SVC and related accounts to another card or a checking account.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

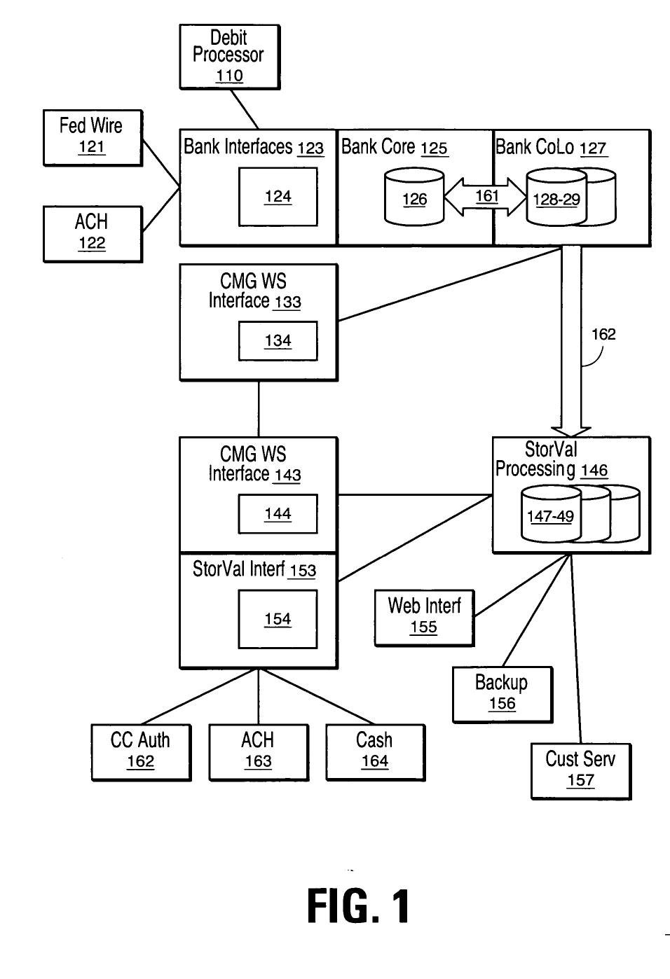

FIG. 1 illustrates a number of computer implemented services and databases interacting, with physical changes to the recorded account balances stored in the databases. In this embodiment, the Bank implements banking interfaces 123, a bank core financial system 125 and a bank co-located financial system. The Bank also provides an interface for stored value card transactions 133, in this embodiment a Web services facility.

The core Bank system communicates with an electronic funds debit processor 310 for ATM and point-of-sale transactions via an ISO 8583 message block protocol. The Bank also uses an ISO 8583 message block protocol to connect to the Fed Wire 121. A third-party ACH originator connects the Bank using a NACHA file format to an ACH clearinghouse 122. The third-party ACH originator is associated with a sponsor bank that has direct access to the ACH clearinghouse.

The Bank's processing systems may be separated between the Bank building and a co-location center. For instance, the Bank interfaces 123 and Bank core's processing 125 may be located in the Bank building and the bank co-location 127 located offsite. In the embodiment depicted, the Bank core 125 utilizes an Oracle database or database cluster 126. Replication processes 161 employ OBDC to translate the Oracle format into an SQL database 128, in a bidirectional replication, with usual record or field-level locking and logging. An additional replication service 162 provides a unidirectional replication from the Bank core 125, which is replicated at the bank co-location 127, to a stored value processing center 146 and replicated database 147. Use of the intermediate, replicated SQL database 128 facilitates load-balancing, but is not essential. For instance, an Oracle database cluster could provide load-balancing and share processing of Bank core functions with shared value card-related functions. Then, the unidirectional replication could connect the Bank core database 126 to the stored value processing center and database 147.

Web services collector 134 at the Bank's Web services facility 133 is connected to a Web services requester 144 at the stored value card facility 143. The Web service facility could be house with the Bank's core system 125, it co-location 127 or a separate location. XML messages implement the Web services interface, in one embodiment. Changes to the SQL database are communicated by the Web services collector 144 to the database 128 at the bank co-location 127. Alternatively, a secure socket layer protocol and post transaction could be used to convey messages, instead of an XML Web services protocol. Or, CORBA protocol could be used to implement an interface for stored value card transactions. Other secure messaging protocols also could be used, including standards-based and proprietary protocols. A variety of services make up the system, which are described in greater detail below. These functions allow real-time inquiry to and update of the replicated Bank core data.

A card history database 129 also is maintained.

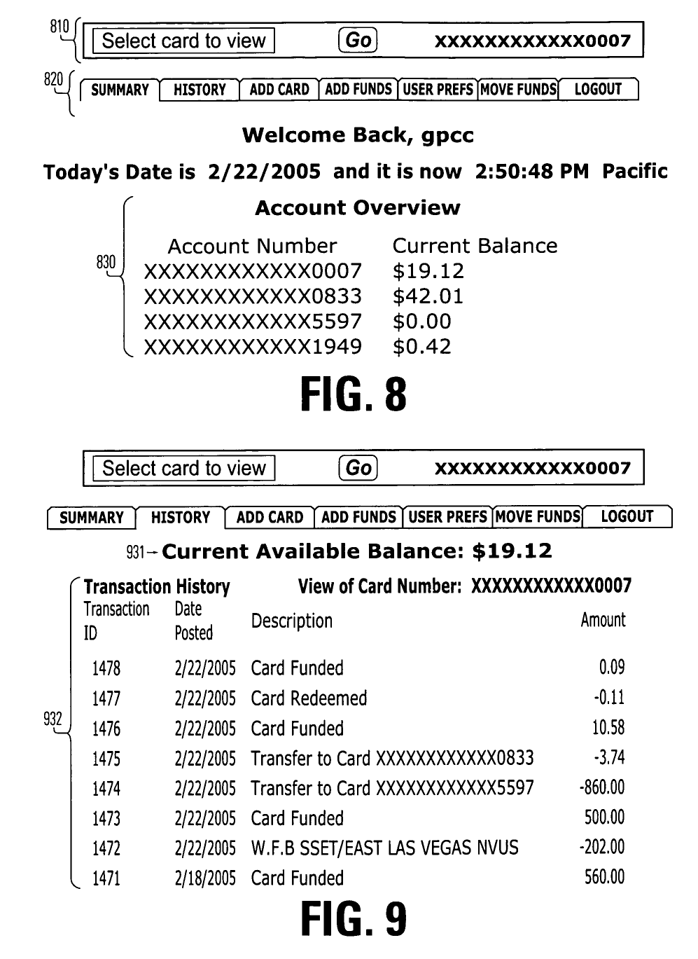

The stored value processing center 146 replication may include information from the core database 128, stored in 147, and the card history database 129, stored in 148. A transaction history also is maintained 149, which records to the history of messages between the Web services requester 144 and the Web services collector 134. The transaction history also reflects interactions between a consumer-facing interface 155 and the stored value processing 146. Interactions at the consumer-facing interface are described in further detail below, with respect to FIGS. 8-20. The stored value processing 146 also interacts with backup 156 and customer service 157 logic and resources.

The stored value processing center 146 interacts with both the Web services requester 143 and a stored value outside services interface 153. The stored value outside services processor 154 uses proprietary or standard formats to access banking services provided by others for credit card authorization 162, ACH transactions 163 and cash deposits 164. Separate ACH services 122, 163 for the stored value processing center and the bank core system are provided because of asymmetry between the cost of pushing and pulling ACH transactions.

We will return to FIG. 1 to describe particular transaction sets, after identifying processing blocks, accounts and transaction flows.

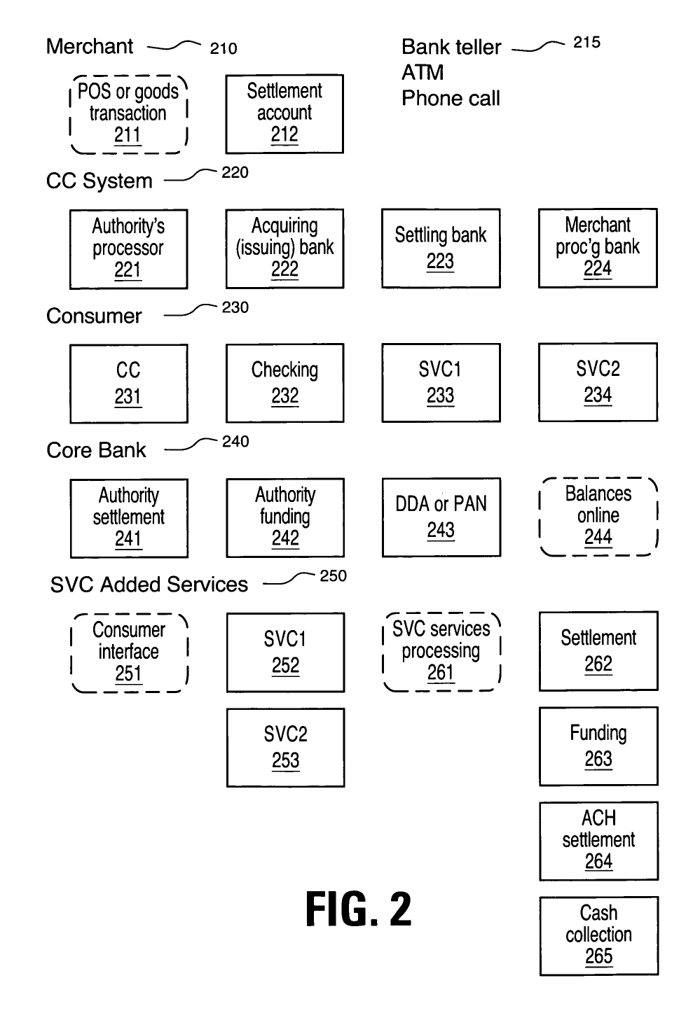

FIG. 2 depicts some processing functions and some accounts, organized by party. The parties identified include one or more merchants 210, which may be online or brick-and-mortar merchants. Other parties involved in the consumer's cash flow include bank tellers, ATM machines, phone call services (collectively 215) and credit card systems (such as MasterCard®) 220. Activities of the consumer 230 include interactions with a stored value card added services 250 authority and a core Bank 240, which processes accounts for the added services. The consumer is generally unaware of the details of and interactions behind the financial transactions. Many publications that describe ultimate services to consumers provide no details or interaction description and are not helpful in advancing or improving services.

A merchant 210 may have a point of sales terminal 211 that is used to load funds on the stored value card, and may sell goods or services, accepting payment by debit card 211, credit card or by scanning a paper check and converting into an electronic ACH item. On the banking side, the merchant 210 will have a settlement account 212, and possibly separate settlement accounts for delivering funds loaded to the stored value card and for receiving payment for goods or services.

The credit card system 220 will include a processor 221 acting on behalf of the transfer authority that implements the stored value card added services 250. The standard configuration for other banks participating in a credit card transaction is a card association such as MasterCard® 223 associated with the credit card issuing bank, an issuing bank 222 that issues the credit card to the consumer 230, and a merchant processing bank 224 which handles transactions on behalf of the merchant 210. Within approximately 48 hours of a credit card transaction, the card association obtains funds from the issuing bank 222, deducts transaction and interchange fees and pays the balance to the merchant processing bank 224. The transaction fees are usually on a per transaction basis. Interchange fees are on a percentage basis, which may vary. One or both fees are collected to compensate the banks and the card association for processing.

The consumer 230 may have a variety of accounts, including one or more credit card accounts 231, one or more checking accounts 232, and one or more stored value card accounts 233, 234. The stored value card accounts 233, 234 may be associated with one or more demand deposit accounts. Either a pooled account at an FDIC-insured bank or savings institution or an individual demand deposit account may be used. The FDIC insurance qualification is optional for some stored value cards and mandatory for cards tied to individual demand deposit accounts.

In this context, a demand deposit account, also known as a demand account, is a deposit account held in a bank or other financial institution, the funds deposited in which are payable on demand. A purpose of demand accounts is to facilitate cashless payments by means of check, bank draft, direct debit, electronic funds transfer, etc. Examples of demand and accounts include checking accounts, current accounts (United Kingdom), shared draft accounts (in United States credit unions), savings accounts (Australian banks) and cheque accounts (in New Zealand banks). In at least the United States, savings accounts also can be accessed by electronic transfer on demand.

Collectively, the merchant 210, other financial vendors 215 and credit card system 220 offer a variety of avenues for transferring value onto or redeeming value from the stored value card or into and out of a demand deposit account associated with the stored value card. As will be further explained below, money can be transferred onto the stored value account 233, 234 and/or the deposit account associated with the stored value card from a point of sales terminal 211, from cash deposits at a bank teller 215, by operating an ATM 215, from a credit card 231 through the credit card system 220, or from a checking account 232 through the ACH system.

Money can be transferred from the stored value account 233, 234 and/or the deposit account associated with the stored value card for goods transaction 211 with an online or bricks-and-mortar merchant 210, by operating an ATM 215, to pay for phone call 215, to pay a credit card balance 231, to make a deposit to a checking account, or to transfer value to another stored value card 234. This distinguishes the stored value account 233 in this application from gift cards that include legends such as, “this card can be used only for purchases of merchandise that any (vendors outlet) in United States and Puerto Rico. This card cannot be redeemed for cash and no change will be given, except in those states which require redemption for cash. After a period of time specified in the Cardholder Agreement (usually 3 to 12 months), a service fee of two dollars per month or more will be deducted from the remaining balance of the card (except for cards sold in states where this is otherwise prohibited by law.) The stored value account 233 in this application also has distinguished from gift cards, which the vendor outlet is required to treat as bookable revenue upon sale, without waiting for redemption of the card value in merchandise or services.

While these descriptions of a stored value card evoke the image of an ATM-card like device, a stored value card could, more generally, be embedded in a cell phone, PDA or other computer-implemented device. Generally, a stored value card provides a user with a Plastic Account Number (PANum) and may be used in conjunction with an additional authentication factor. The additional authentication factor may be a personal identification number (PINum) or other factors that give some assurance that the person using the card actually has the card in their possession. The additional factor may include a cryptographic key or a biometric measure. Cryptographic keys may conform to PSK signing protocols. Biometric measures may include fingerprint recognition, voice recognition, face recognition or retinal scans.

The core bank 240 satisfies banking regulations and maintains certain accounts associated with the stored value card. In some claims that follow, we refer to the added services provider for the stored value cards as a trusted transfer authority. The added services provider is a transfer authority in the sense that the consumer relies on the added services provider to authorize, facilitate or request transfers among accounts on the consumer's behalf. The added services provider is trusted by the core bank to make requests. Security measures agreed between the core bank in the added services provider will authenticate requests as coming from the trusted transfer authority. The core bank typically will provide online access to account balances.

The trusted transfer authority typically will have at least one settlement account 241, at least one funding account 242 and control over one or more demand deposit accounts 243, which may be individual accounts per consumer or an aggregated account associated with numerous plastic account numbers for individual consumers. One or more settlement accounts are used to honor obligations of the trusted transfer authority to others and to receive promised funds from others. For instance, ACH transfers are processed through the settlement account 241.

One or more funding accounts 242 are used to advance funds held by the trusted transfer authority into DDA or PANum accounts 243, while settlement of transfers from other financial instruments is awaited. Use of the funding account is contrary to capturing the float, as the trusted transfer authority makes value available to the consumer through the DDA or PANum 243 while the float is with someone else, before settlement reaches the trusted transfer authority's own account. This is different from the courtesy access to part of deposited funds or a small amount of deposited funds that a bank receives an ATM, for instance, because substantially the full amount of a transfer is advanced on behalf of the consumer, not a small part, because the transfer has not been made at an ATM or other facility owned or controlled by the trusted transfer authority, and because the funding is made in reliance on arrangements between the trusted transfer authority and other financial institutions, as opposed to being made in reliance on a history of financial activities between the consumer and the trusted transfer authority. Transaction processing is directed between the trusted transfer authority and the other financial institution. While a consumer account may be blocked, frozen or flagged and unusual transaction patterns may be used to detect fraud, advanced funding is in reliance on arrangements with the other financial institutions and not a courtesy to the consumer dependent on accessing a history of the consumer's financial activities or proxy for the consumer's financial activities history. This is useful to unbanked consumers who are accepting their payroll, for instance, using a stored value card or to undesirable consumers who have an unfavorable financial activities history. For consumers who have credit cards and still desire the safety and convenience of a stored value card, loading value from their credit cards with immediate funding is a significant benefit.

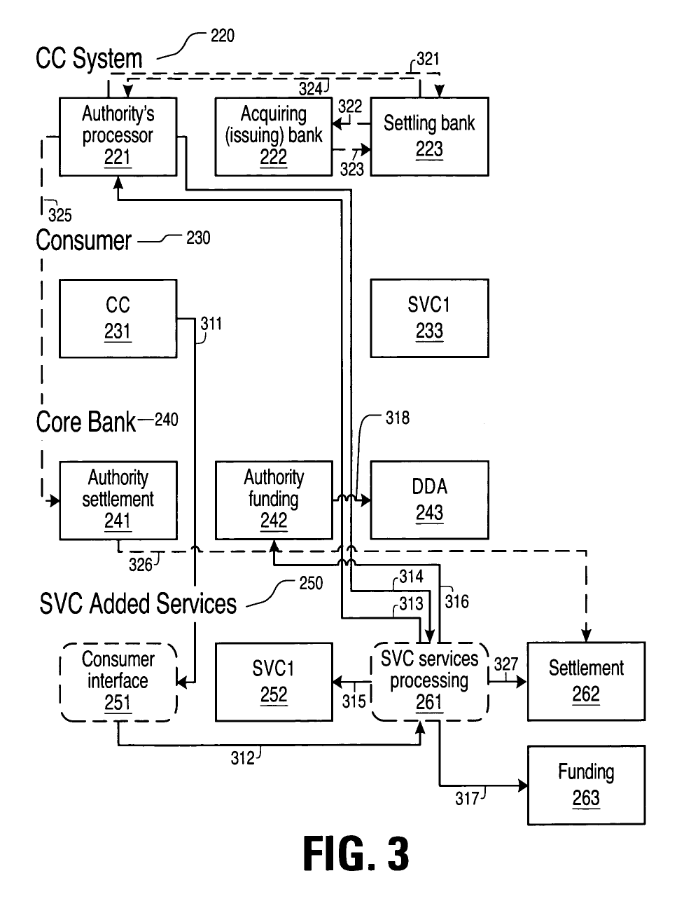

The added services provider 250 maintains accounts for stored value cards 252, 253 and for its own accounts, such as settlement 262, funding 263, ACH settlement 264 and cash collection 265. The added services provider makes available a consumer facing interface 251 and operates stored value card services processing 261. Examples of a consumer interface are provided in FIGS. 8-20. Stored value card services processing 261 is accomplished using a computer implemented system, such as the embodiment depicted in FIG. 1. The flow of some stored value card services processing functions as illustrated by FIGS. 3-7.

FIG. 3 is a high-level block diagram of loading value from a consumer's credit card into a demand deposit account. Again, a demand deposit account, unlike the retail store gift card, facilitates electronic banking transactions. Loading value from a consumer's credit card into a demand deposit account involves at least the credit card system 220, the consumer 230, the core bank 240 and the added services provider 250. At a terminal or online, the consumer 230 may present 311 their credit card 231 to a consumer facing interface 251. For instance, a terminal may be provided with the display adapted for this purpose and a card reader through which the consumer swipes the credit card. Alternatively, an online interface may be provided which a consumer can access from their own or a friend's PC with Internet access. The consumer interface 251 invokes 312 services processing 261. Services processing 261 communicates with a credit card transaction processor 221 under contract with the trusted transfer authority to request an authorization 314 for the transaction. This authorization request is coded to identify the type of transaction. As the credit card system 220 does not have, prior to these inventors' efforts, a transaction code that corresponds to loading funds from a credit card into a demand deposit account, the request and authorization will be specially coded. Over time, the special coding may become widely adopted. Upon receiving the authorization 314, services processing 261 causes the balances in certain accounts be changed. The ledger balance for the consumer stored value card account 252 is increased 315 and the ledger balance of the funding account 263 is decreased 317. This corresponds to sending the core bank 240 a request 316 to move money 318 from the authority's funding account 242 into demand deposit account 243 associated with the consumer's stored value card. Referring to FIG. 1, it can be seen that the record of increasing the stored value card account 252 and decreasing the funding account 263 balances may be logged in a transaction log database 149 and replicated 162 to the stored value processing database 147 by processing through the SQL database 128. An additional log of the balance change and stored value card history may be replicated 162 from a bank transaction log 129 to the stored value processing center 146 database 148. Processing after the consumer request is forwarded 312 to services processing 261 takes less than seven seconds and be implemented in 300 ms or less. When the bank transfers 318 funds from the funding account 242 into the DDA 243, the available balance of the stored value card 233 associated with the DDA 243 becomes available in real time.

Settlement between the credit card system 220 and the added services provider 250 follows the advance of funding 318 to the consumer's shared value card 233. Under credit card system current arrangements, it may follow by 48 hours or more. In one embodiment, the authority's credit card processor 221 makes a settlement request 321 to a settling bank 223. The settling bank exchanges messages 322, 323 with an acquiring or issuing Bank 222 that issued the consumer credit card 231. Having obtained the funds, a settling bank 223 transfers 324 the value to the authority's processor 221 or its bank, if the processor 221 is not a bank, and the value is transferred 325 to a settlement account 241. The core bank 240 informs services processing 261 that the funds have been received and the ledger balance in the settlement account 262 is increased 327. Again, the ledger balance may be increased by replication 162.

Unlike a retail store gift card, funds advanced 318 from a consumer credit card 231 to a demand deposit account 243 are not bookable as a sale but rather as a financial service transaction for which the retailer may charge a convenience fee. Retail store gift cards are immediately bookable, offset by a liability, because the retail store has sold the card and promised to deliver goods of equivalent value. The retail store configures gift card transactions to be immediately bookable so that they appear as revenue on the store's books. This is particularly useful to large chain stores. It is inconsistent with making the stored value available at a variety of financially unaffiliated stores or for cash withdrawal through an ATM. Retail stores do not have the banking qualifications to extend their systems in this way and are motivated against doing so. One embodiment allows a participating card association or ATM network to facilitate loading of stored value debit cards from credit cards with immediate funding of the store value card balance but without risk to the merchant.

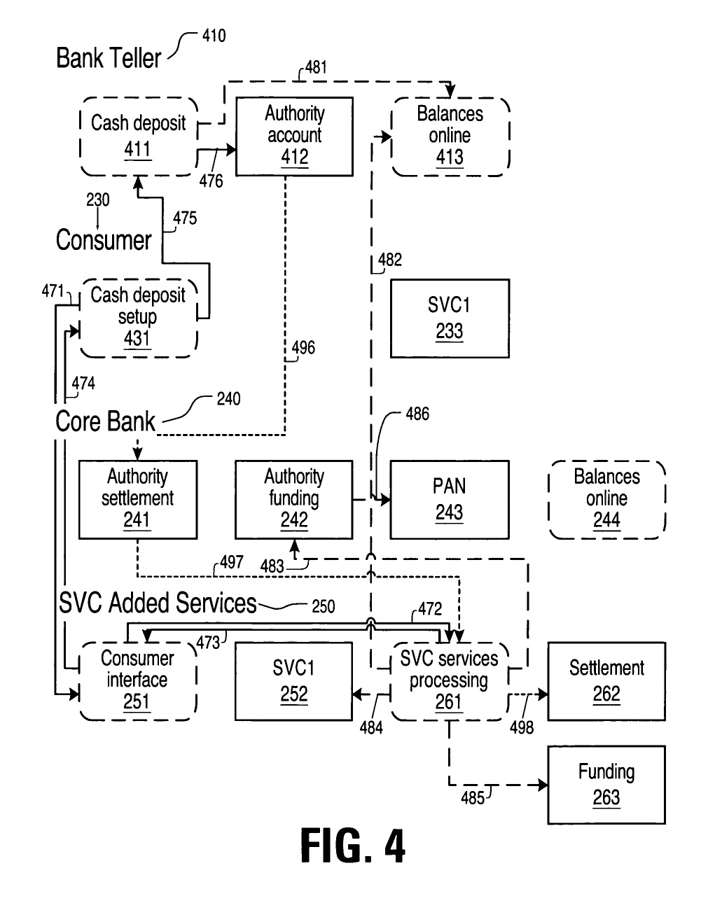

FIG. 4 is a high-level block diagram of processing a cash deposit in multiple parts with a bank teller and making the funds available through a stored value card once the bank teller's receipt of cash has been posted as an online balance update. In overview, this approach allows an unbanked consumer to make a plurality of cash deposits at a teller window and have the deposited cash become available within minutes or hours through the consumer's stored value card. The consumer indicates how much money they want to deposit and the added services provider specifies two or more deposits to make, dividing the total amount into two distinctive deposits into one or more accounts controlled by the added services provider. These accounts are restricted to accept cash deposits only, not checks or other financial instruments. The added services provider can confirm that the cash deposits have been made either through an interface arranged with the bank or by so-called “scraping” of an on online interface designed by the deposit recipient bank for human review.

In FIG. 4, the consumer on the 230 initiates a cash deposit set up 431. The consumer uses 471 a consumer facing interface 251. The interface 251 interacts 472 with added services processing 261, which provides 473 instructions for a plurality of deposits that the consumer will make at a bank teller 410. The instructions are relayed 474 back to the consumer. The consumer completes two or more deposit slips, presents them 475 to the bank teller 410 with the cash deposit 411. The bank credits the cash 476 to an account controlled by the added services provider 412. The bank's standard processing systems update 481 the online available balance 413 corresponding to the account 412. This online balance may be of the sort displayed to the consumer using a browser or may be an XML or other type of message file intended for computer-to-computer interactions, without human display. The online balance may be updated instantaneously or at some time after the consumer leaves the bank teller window.

The added services provider gives the unbanked consumer deposit instructions that reliably allow the added services provider to recognize deposits by the consumer into an account not controlled by the consumer. For instance, if the consumer wanted to deposit $100.00, the system might specify cash deposits to a single account of $35.71 and $64.29. The system would reserve those two amounts against reuse within a specified time or until they had been received by the bank and recognized by the system. Optionally, the amounts could be reserved against reuse until deposit slips had been verified, to confirm the depositor's identity and/or intent. Other combinations of deposit instructions could be used. For instance, three or more deposits totaling the desired deposit amount could be specified. Or, more than one account could be specified. Or, a specific bank branch at which to make the deposit could be specified. Those of skill in the art will recognize other ways in which a combination of deposits could be arranged so that they could reliably and automatically be recognized.

In one embodiment, the added services processing 261 polls the balances online 482 download a recent transaction history for the account. Depending on the bank's updating cycle, this polling may take place every hour, half-hour, 10 minutes, five minutes or minute. The frequency of polling is adjusted to provide a consumer timely access to the deposited cash without overtaxing online access of account balances. The cash typically will be deposited at a bank other than the core bank 240. Accordingly, added services processing 261 sends a message 483 authorizing a transfer 486 of funds from a funding account 242 to an account associated with a plastic account number 243 and with the shared value card 233. Added services processing logs the transaction and updates the ledger balances 484, 485 of the shared value card 252 and the funding account 263. As above, these balances may be updated as a result of replication 162. In a separate timeframe, the added services provider 250 can use the ACH interface 163 to move funds 496 from the cash deposit account 412 to a settlement account 241. Upon receipt and settlement account, the core bank 240 advises receipt 497 and a settlement account 262 ledger balance is updated 498.

This approach is quite remarkable because it allows availability without waiting overnight for funds deposited in a first bank into an account not controlled by the consumer, through a stored value card not issued by the first bank. While bank-to-bank messaging of account balances may be useful, it is not necessary to implement this funds availability strategy.

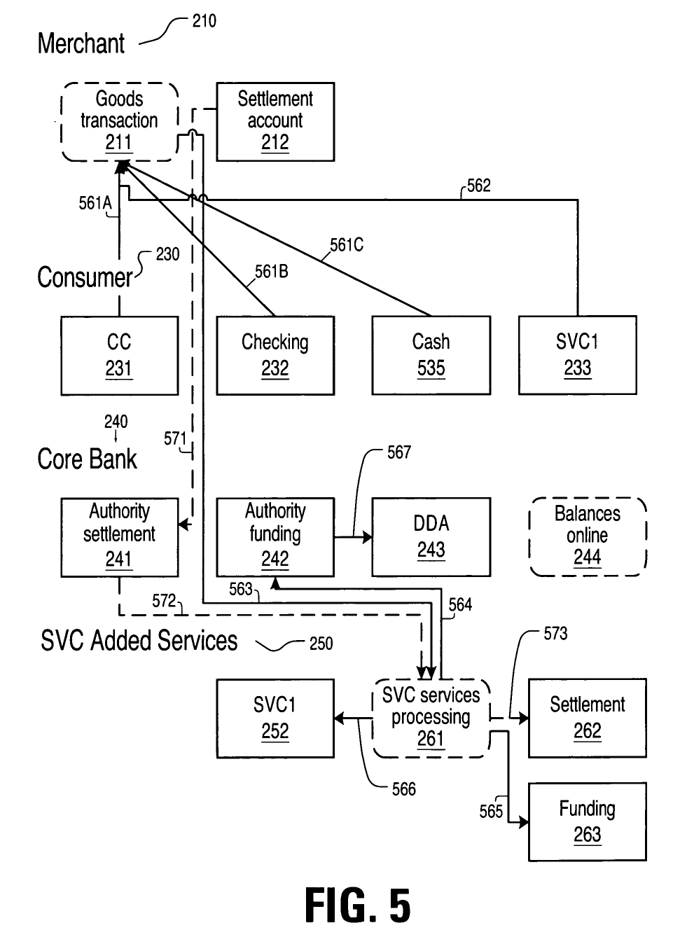

FIG. 5 is a high-level block diagram of a consumer 230 adding value to a demand deposit account 243 associated with a stored value card 233 from a credit card 231, checking account 232 or cash 535 at a merchant's 210 point-of-sale terminal. Adding value to the stored value card is configured at the merchant point-of-sale terminal as a goods or services transaction 211, similar to buying and activating a retail gift card or a phone card. The consumer 230 goes to the store 210 and selects a transaction for adding value to a stored value card, for instance by presenting the checkout clerk with a hang tag card that represents $50. Alternatively, the consumer 230 can tell the checkout clerk that they desire to add value to stored value card at the checkout clerk can use a list of SKU codes and a scanner or keypad entry to initiate the transaction. The consumer presents the clerk 561A-C with a credit card 231, a check 232 or cash 535. In addition to the checkout clerk invoking the transaction, the checkout clerk needs to learn 562 from the consumer 230 the account number of the stored value card 233 to which the value will be added. The consumer may swipe the stored value card, show it to the checkout clerk or otherwise communicate the appropriate account number. The point-of-sale terminal system performs whatever authorizations the merchant 210 desires, depending on how the consumer 230 adds value, and advises 563 the added services processing 261 of the added value transaction. When the added services processing 261 receives notice that the merchant sold the added value to the consumer, the added services processing 261 sends a message 564 to the core bank 240 authorizing transfer 567 from a funding account 242 to a demand deposit account 243 associated with the stored value card 233. Settlement 571 typically occurs overnight, from the merchant settlement account 212 two the added services settlement account 241. The core bank 240 advises the added services processing 261 that funds have been received 572 and the ledger balance the settlement account 262 is updated 573.

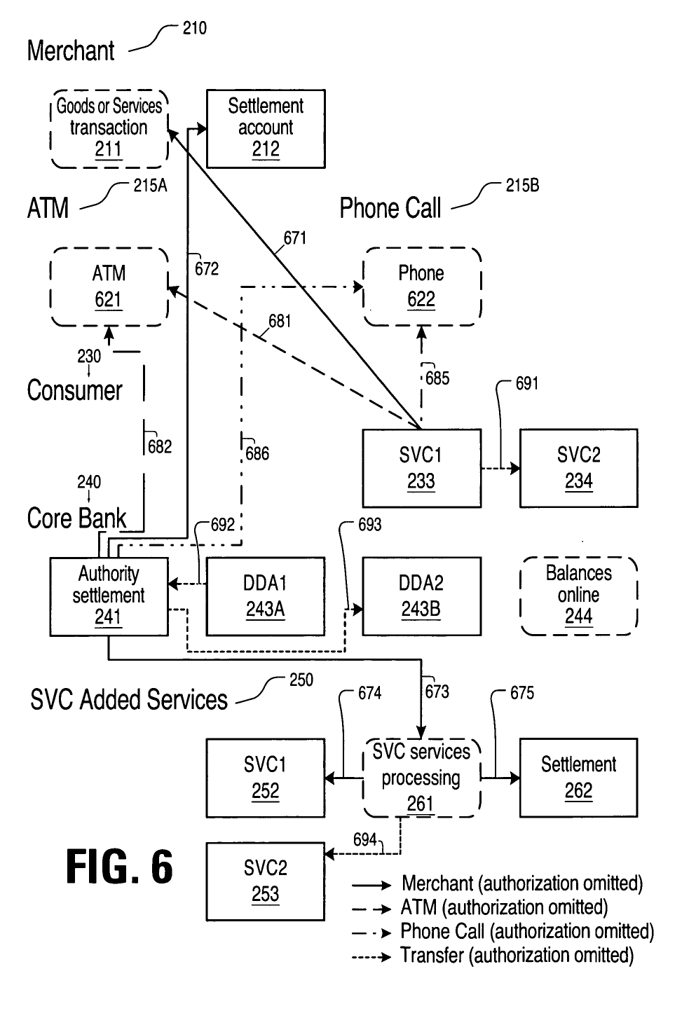

FIG. 6 is a high-level block diagram, omitting authorization steps, of redemption of value from a stored value card 233. The consumer 230 has several ways to access value in the stored value card 233. The consumer can redeem value at an ATM 621, by buying goods or services 211, by placing a phone call 622, or transferring value to another stored value card 234. The network and banking services used will depend on how the value is redeemed. For instance, if the consumer 230 goes to an ATM 215 and executes a transaction at the ATM 621, value will be transferred 681 from the stored value card 233. For instance, the PULSE, STAR, CIRRUS. PLUS, MASTERCARD or VISA system may be used to immediately transfer value.

When the consumer 230 goes to merchant 210 to execute a goods or services purchase 211, value is transferred 671 from the shared value card 233 to the merchant using a debit card system, such as the PULSE, STAR, CIRRUS. PLUS, MASTERCARD or VISA system. The value is transferred immediately. Accounts are reconciled daily and settled 672 to the merchant settlement account 212 from an added services settlement account 241.

When the consumer 230 goes to a phone system 622 to place a phone call 215B, value can be redeemed from the stored value card with settlement 686 in due course.

The consumer 230 also can move value 691 from one stored value card 233 to another 234. While the figure illustrates money moving 692 within a core bank 240 from a first demand deposit account 243A to a settlement account 241 and on to 693 a second demand account 243B, the two demand accounts could be in separate banks. Funds could be moved between banks, for instance by ACH transaction. The first account could be a plastic account number account, instead of a demand deposit account. One use of this kind of transfers is for foreign workers to send money home. Foreign workers in some areas may be satisfied with a stored value card associated with a plastic account number, because the stored value card can be used even at an ATM; relatives at home sometimes need a demand deposit account or wire transfer, if they have less access to banking infrastructure.

As in the prior figures, when actions taken by the core bank 240 to disburse funds from the settlement account, a message 673 is sent to services processing 261. Account balances are updated 674, 675, 694, by replication 162 or otherwise.

For clarity, many steps of redeeming funds have been omitted from the flow depicted in FIG. 6, including authorization steps.

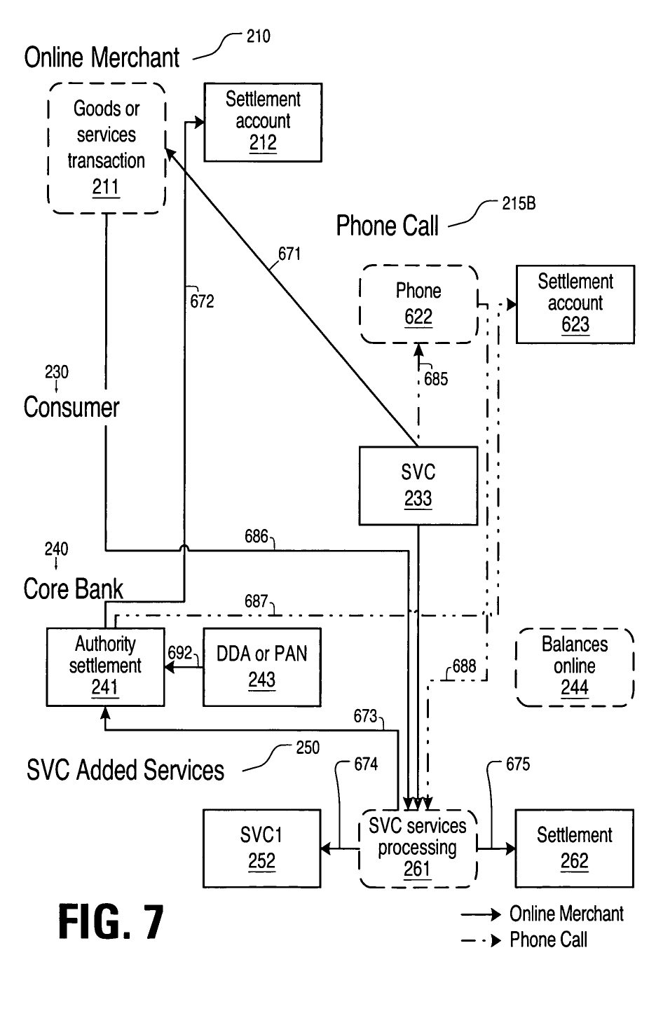

FIG. 7 illustrates an authorization process that may be applied to telephone calls 215B or online merchants 210. Consider a telephone call. The consumer uses the stored value card 233 to pay for the phone call by providing 685, for instance, a plastic account number and PINum. The phone system 622 communicates 686 with the added services processing 261 to secure incremental authorizations. For instance, the initial authorization may be for the estimated cost of a three-minute phone call. Added services processing 261 contacts the core bank 673 and requests a hold on or transfer from the consumer's DDA or PANum account 243 to the settlement account 241 of the estimated cost. The added services processing 261 sets an expiration for the hold or a time for reimbursing the consumer's account 243. If the time expires without the funds being earned for a telephone call, the hold is automatically released. For instance, a three minute hold might be released after 3:01 minutes or 4:00 minutes, allowing a predetermined time in addition to the incremental time for completion of the call and processing actual costs after the caller hangs up. The added services processing 261 then authorizes the phone call to proceed and cost to be incurred up to the estimated cost. If the telephone call proceeds, the phone system 622 sends an additional message 686 advising the added services processing 261 that a certain amount has been earned. If the call fails, the phone system 622 may send a message indicating a zero-time, zero-cost phone call, which could trigger a release of the hold prior to expiration of the release timer. The earned amount is accounted for so that it can be periodically settled 687 into the settlement account 623. If the phone call proceeds close to the time estimated and the authorized cost, as the end of the predetermined time approaches, a further message 868 is sent to request an additional, incremental authorization. The added services processing 261 continues to process requests 673, place holds, and provide authorizations on an incremental basis. At the end of the phone call, the earned amount message 686 is sent by the phone call system to the added services processing 261 which accumulates the charges and periodically authorizes settlement 687.

The phone system 622 or phone services vendor may receive value only as phone calls are placed, on a pre-negotiated basis. Alternatively, the added services processor 250 may act as a phone services vendor and prepurchase capacity for phone calls. Then, the added services processor 250 earns the right to deduct money from the consumer's stored value card 233 only when phone calls are made. The added services processor has a relatively low risk of fraudulent use of the stored value card to place phone calls because phone calls are only allowed if value is available to be held or transferred. The consumer benefits from enjoying rates similar to pre-paid calling without committing funds on their stored value card until they actually make a phone call.

Consumer Facing Online Interface

FIGS. 8-9 depict summary and history information for one or more accounts, which may be PAN or DDA accounts. User online interfaces will often include 810 an option for a user who may hold more than one SVC to select a card to view, for instance from a pull down menu, and a proceed button. Online interfaces often include a view selector 820, such as tabs or a framed list on the left or right side of the screen. In FIG. 8, a list of accounts with current balances 830 is depicted. In FIG. 9, the current available balance 931 and transaction history 932 of a selected account are depicted.

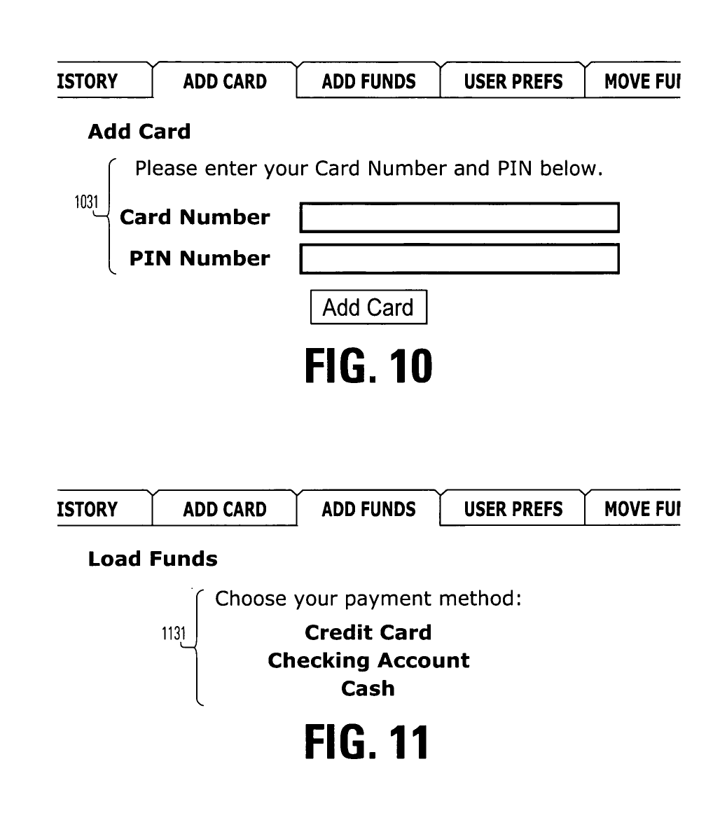

FIG. 10 depicts adding an account with a PIN as an additional authentication factor to a user's stored value card. The account may be a credit card, checking account or a destination account. The user supplies 1031 both the account number and authentication factor, such as PIN number. The user also may supply a CVV/CVC code from the back of the card and may supply address information, such as their billing address and zip code.

Another method of verifying the owner of a bank account can be applied to a credit card account or a debit card account without any face-to-face contact. According to one embodiment of this method, the consumer is told that two different drafts will be made on his account totally $2 (or some other amount) but that the actual amount of the two drafts will not be known to him. (Alternatively, deposits or other transactions could be used, in lieu of drafts.) The consumer accesses his account information using his personal account information provided by his financial institution. The consumer determines the amounts of the two transactions and returns to the web services or telephone services of the invention to enter the amount of the two transactions. The consumer's entries are compared to the amounts of the drafts made by the authorization authority. If they match, then the account is verified because it would be impossible for the consumer to know the exact amounts without having the proper access to view the account and impractical to guess. Random guessing is unproductive, because the consumer is locked out after a limited number of tries, such as only two incorrect tries. The total number of possible combinations of two different numbers from $0.01 to $1.99 minimizes the possibility of accidental determination within only two tries. If greater security is desired, the draft may total $3, $4 or some other amount greater than $1 that the consumer is told to find in his account information.

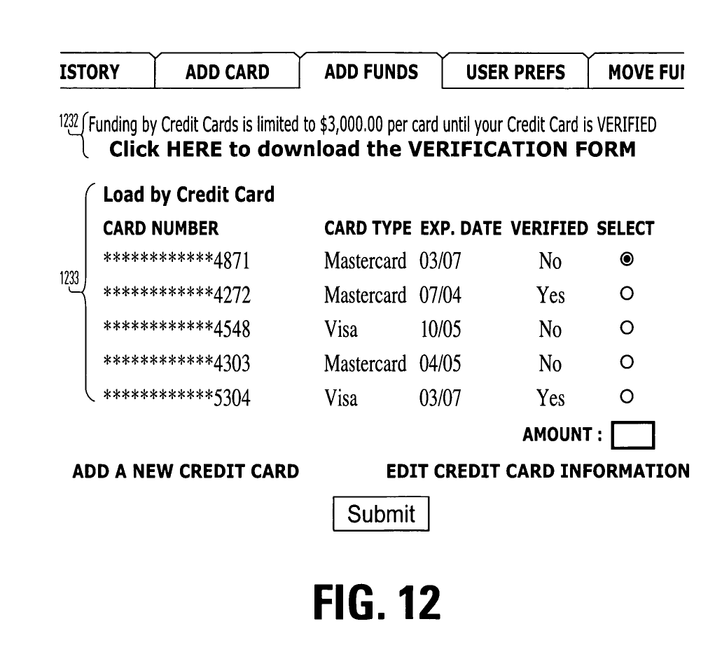

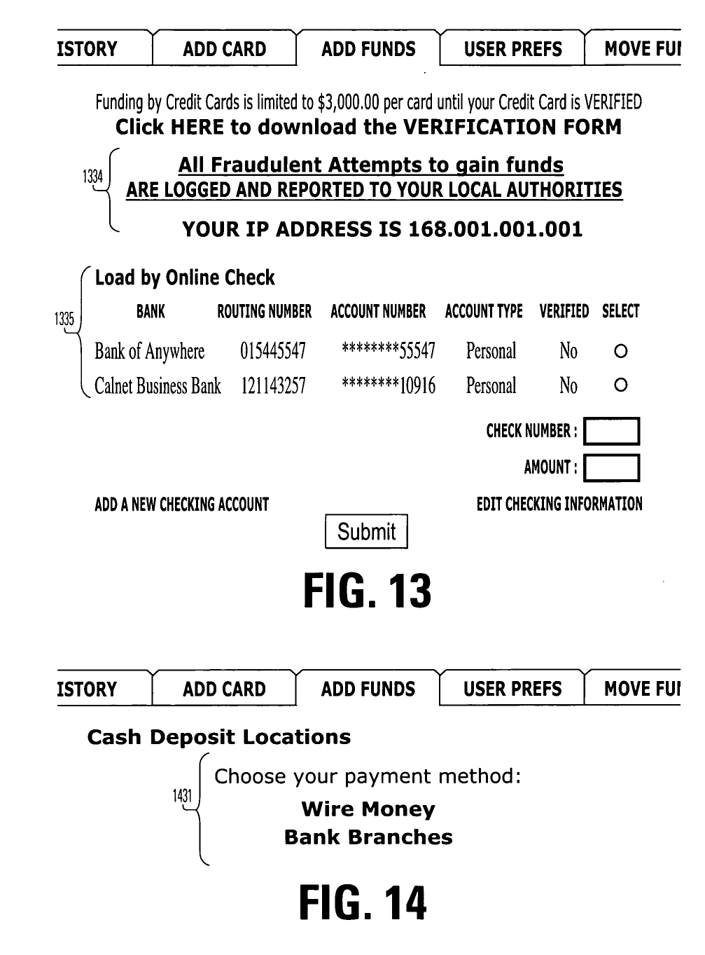

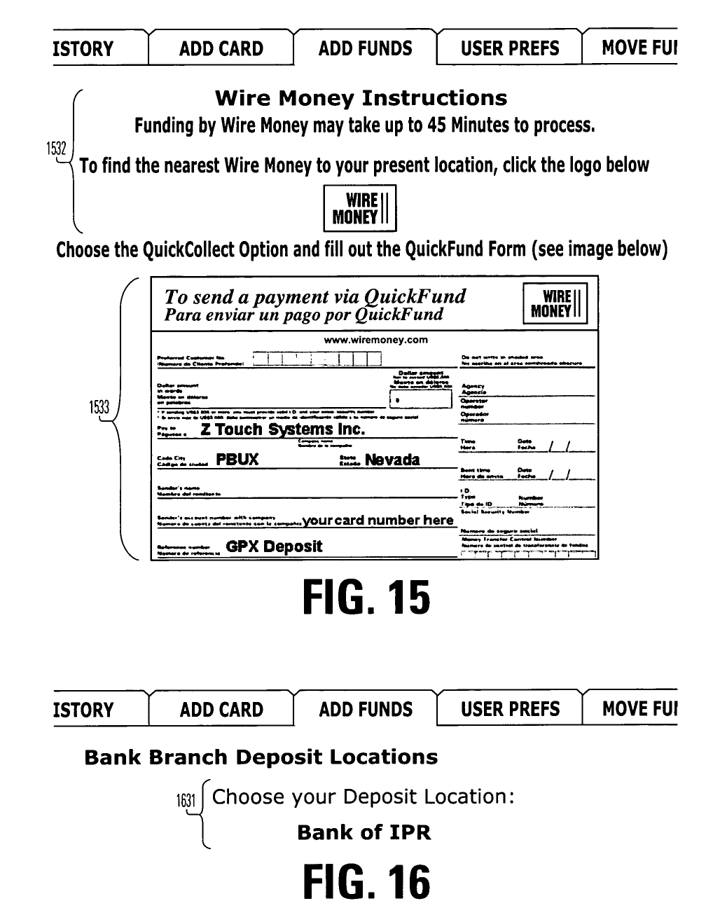

FIGS. 11-17 depict adding value to an SVC and related accounts from a credit card, checking account or cash deposit. In FIG. 11, the user selects from a list 1131 of type of add funds sources. FIG. 12 shows loading value from a credit card to a stored value card. A notice and option to verify the credit card are offered 1232. A list of available credit cards 1233 also are presented. FIG. 13 shows loading value from a online accessible checking account, typically at a bank other than the core bank, for instance by ACH transfer, to a stored value card. The IP address from which the request originated is displayed 1334 along with a fraud deterrent warning. A list of already added checking accounts 1334 is displayed, among which the user chooses. FIG. 14 shows selecting a method of loading cash to a stored value card. In this embodiment, the choices 1431 are to wire money, which typically requires cash, or to deposit cash in a branch bank. For a wire transfer, FIG. 15 depicts instructions given to the user. General and locator information are provided 1532. A sample form, to guide the user in completing the form, is also provided 1533.

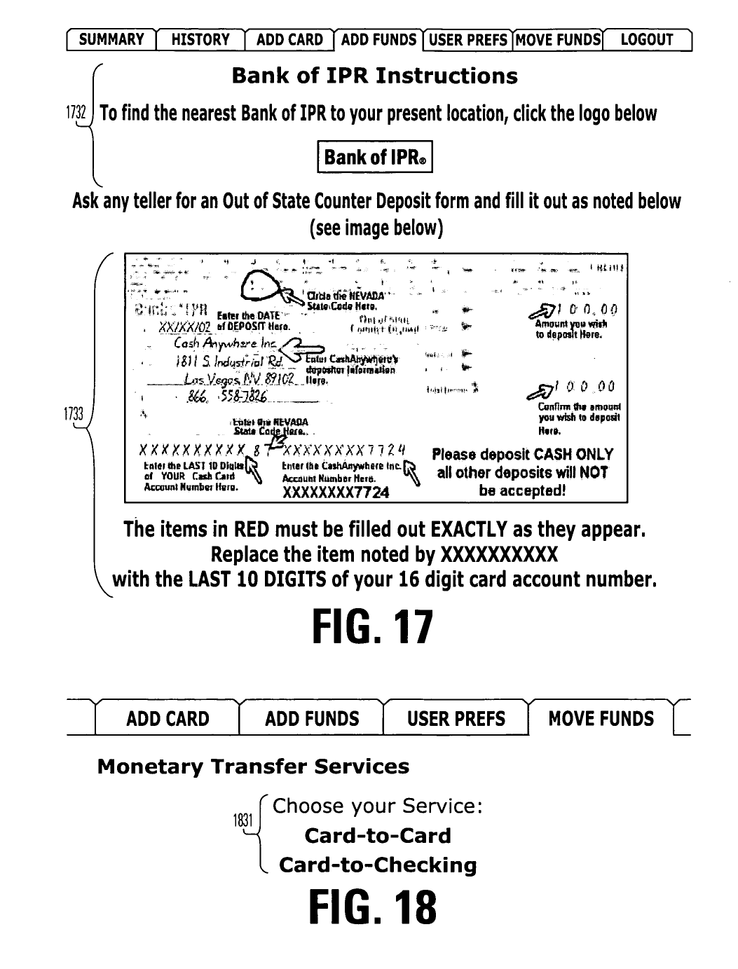

FIGS. 16-17 depict parts of the method for loading cash by handing it to a bank teller. FIG. 16 allows a user to select a bank 1631. This may be refined to allow the user to select a particular branch at which the deposit will be made. In FIG. 17, a sample form, to guide the user in completing the form, is also provided 1733. A user's deposit can be captured from a single amount, by manually viewing the imaged deposit slip online, once it becomes available. As described above, interface screens not shown here can be used to break a certain sum for deposit into two or more deposits to one or more accounts. Multiple sample forms would be displayed for the user, one for each deposit to be made.

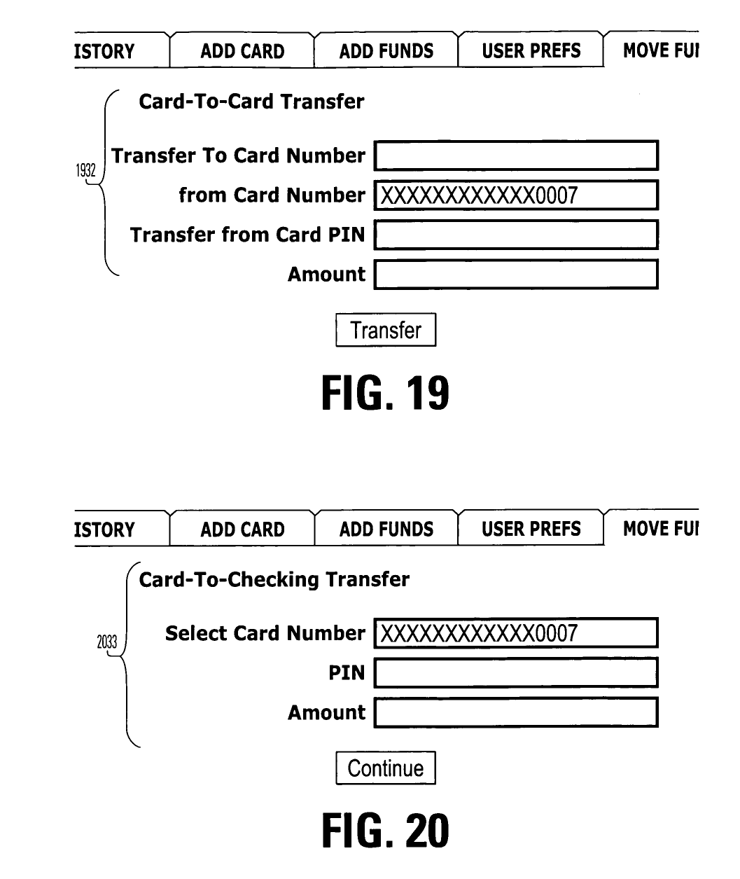

FIGS. 18-20 depict redeeming value by transferring it from an SVC and related accounts to another card or a checking account. FIG. 18 presents the user a choice 1831 between redemption by transfer to another SVC or by moving money into a checking account. Selection of a card-to-card transfer invokes a screen such as FIG. 19, which elicits 1932 the card numbers of the source and destination cards, an authentication factor for at least the source account, and an amount to be transferred. Selection of a card-to-checking transfer invokes a screen such as FIG. 20, which elicits 2032 the account number of the destination account, an authentication factor, and an amount to be transferred.

Consumer Facing Interactive Voice Response Interface

A second consumer facing interface may be an interactive voice response (IVR) system, which allows a consumer to work with the system via a telephone, without any need for a monitor, or using VoIP telephones. The system may interact with the Core Bank through the WSR/WSC interface described above, using XML messages, or may employ some other interface. The IVR menu allows a user to retrieve information, fund a card or redeem a card. Standard dial-in options for information retrieval are illustrated by the dialogue that follows.

The main greeting may be, “Thanks you for calling Customer Service. Please enter you card number followed by the pound sign.” This input prompt allows entry of 16-19 digit card number plus pound to complete the entry. The system follows with a lookup of the card number in DB to determine the User and PANum associated with the card number. Then, “Please enter your security info (i.e. last 4 of social, zip code, etc.) followed by the pound sign.” The system matches the user's inputted data against the DB by User for security purposes.

A redirect prompt offers the user options, such as: Option 1—Get Card Balance: This service will call the GetCardBalance service to determine the actual balance of the card at the present time. Option 2—Get Last 5 Transactions: This service will call the GetCardHistory service to determine the last 5 transactions of the card at the present time. Option 3—Card to Card Transfer: This service will call the CardtoCardTransfer service to effectively transfer funds between 2 cards. This option allows input for another card number as the destination account. It prompts for PIN and calls Verify PIN service to check security. Option 4—Fund Card: This service will call the FundCard service and allow real-time funding of the card via credit-card or ACH. Option 5—Withdrawal from Card: This service will call the RedeemCard service and allow real-time funds removal from the card via ACH. Option 6—Make a long distance call: This is a standard long distance transport, adapted to be billed securely from stored value funds on card. Option 7—Talk to an operator: This transfers the user to a support agent, to be billed from stored value funds on card. Option *3 transfers to a special application for activating a newly issued card and choosing a PIN code. Option *9 transfers to a special support agent for the reporting of a lost or stolen card. The embodiment also may detect the calling number of the consumer and match it to a telephone in the database for that consumer adding an additional level of security and validation of the caller.

The system may be implemented using a 48 port system (24 V/24 IP) with the ability to grow the system by adding port licenses and additional dialogic boards as necessary.

The basic function for funding of cards through IVR branches from Option 4, to fund a card. The sub menu may prompt, “Press 1 to fund your card with a credit card. Press 2 to fund your card with a checking account.” If 1 is pressed, IVR checks to see which User that card is registered to, e.g., by accessing a remotely available SQL 2000 database. For example, if the user has inputted a PAN of xxxxxxxxxxxxx0007, then run the following SQL statement:

| | |
|---|---|
| SELECT | * |
| FROM | cards |
| WHERE | (panum = ‘xxxxxxxxxxxxx0007’) |

This will give you the “Master” User, which is the first to appear in the record set, if there are multiple results. The DB returns is:

| | |
|---|---|
| 27 | xxxxxxxxxxxxx0007 |
| 1352 | xxxxxxxxxxxxx0007 |
| 5184 | xxxxxxxxxxxxx0007 |
| 12599 | xxxxxxxxxxxxx0007 |

So the “Master” User is “27”. The system checks a user information table for a match for this User.

| | |
|---|---|
| SELECT | * |
| FROM | customerinformation |
| WHERE | (cust_id = ‘27’) |

If NO DATA from this query (empty record set) is returned prompt: “There are no credit cards registered to this account,” and then returns to main menu. When there is data, the DB returns:

```
  27 John Public 4464 John Ave. Las Vegas NV 89102
  Amex
xxxxxxxxxxxx1010 11/04 1 1 1 0 12/20/2002 8:43:56 PM
  27 John Public 4333 Public St. Las Vegas NV 89122
  Mastercard
xxxxxxxxxxxx4272 07/04 1 7727 1 0 1/24/2003 1:39:29 PM
10.0.66.2
```

The typical elements needed for authorization of this card is present in the following fields identifying the user, credit card number and expiration date, zip code, and authorization factor. Now, the IVR should ask the caller which credit card they wish to use (only use the last 4 or 5 digits). “Press 1 to add funds from credit card number 1010 (one zero one zero). Press 2 to add funds from credit card number 4272 (four two seven two). Press 3, Press 4, etc. for more than two cards”. Then, IVR will ask caller to enter the amount of funds to their card: “Enter the dollar amount you wish to load . . . ” For instance, 12*76 is entered. The system computes the convenience fee for the charge. This fee may be coded so that it can easily be adjusted. For instance, a fee of 3.5 percent with a minimum fee of 1.50. The system calculates, desired load amount: 12.76. Convenience fee: 1.50 (which is 12.76*3.5%=0.44, so the minimum fee applies). Total to charge: 14.26. It tells the user, “The total amount charged to your credit card will be Fourteen Dollars and Twenty Six Cents including the convenience fee, Press 1 to complete this transaction, press 2 to cancel this transaction.” If the caller chooses option 1, the system should obtain an authorization, following procedures described above. If approved, the system calls the FundCard service for the amount of load i.e. 12.76 (not including the convenience fee) and separately registers the fee. It reports, “Your Transaction was Successful.” Or, if the transaction was declined, it prompts, “Your transaction was declined by your credit card issuing bank, please choose another funding source.” If the caller chooses option 2, the system prompts: “You have cancelled this transaction”.

The user, at the Option 4 sub menu, could alternatively press 2 to fund their card with a checking account. Similar to the sequence above, if 2 is pressed, IVR checks to see which Cust_ID that card is registered to. For example, if the user has inputted a PAN of xxxxxxxxxxxxx0007, then run the following SQL statement:

| | |
|---|---|
| SELECT | * |
| FROM | cards |
| WHERE | (panum = ‘xxxxxxxxxxxxx0007’) |

This will give you the “Master” User, which is the first to appear in the record set, if there are multiple results. The DB returns is:

| | |
|---|---|
| 27 | xxxxxxxxxxxxx0007 |
| 1352 | xxxxxxxxxxxxx0007 |
| 5184 | xxxxxxxxxxxxx0007 |
| 12599 | xxxxxxxxxxxxx0007 |

So the “Master” User is “27”. The system checks a user information table for a match for this User.

| | |
|---|---|
| SELECT | * |
| FROM | customerinformation |
| WHERE | (cust_id = ‘27’) |

If NO DATA from this query (empty record set) is returned prompt: “There are no checking accounts registered to this account,” and then returns to main menu. When there is data, the DB returns:

1 27 John Public 4464 John Ave. Las Vegas NV 89102
702-555-
1212 01/01/1975 111-22-3333 xxxxxx4514 NV johnq@isp.com
.....Personal USA web IP123.123.123.123 PR-00000005 Bank
of IPR
1125455547 015445547 0 1000

The typical elements needed for authorization of this checking account are present. For instance, the user; account and routing numbers; daily limit (which is the amount that can be funded PER DAY should be constrained to the value contained in the daily limit field. In this case, 1,000.00. In MOST cases the daily limit is 250.00; the exemplary limits has been raised to accommodate John Public's spending habits).

The IVR asks the caller which credit card they wish to use, identified by only use the last 4 or 5 digits. “Press 1 to add funds from checking account number 5547 (five five four seven). (Press 2, Press 3, Etc. for more than one checking account).” Then, IVR will ask caller to enter the amount of funds to their card, “Enter the dollar amount you wish to load . . . ” For instance, 50.00 is entered. The system computes the convenience fee for the charge. This fee may be coded so that it can easily be adjusted. For instance, a fee of 3.5 percent with a minimum fee of 1.50. The system calculates, desired load amount: 50.00 Convenience fee: 1.75 (which is 50*3.5%=1.75, which is higher than the minimum fee). Total to charge: 51.7514.26. It tells the user, “The total amount charged to your credit card will be Fifty One Dollars and Seventy Five Cents including the convenience fee, Press 1 to complete this transaction, press 2 to cancel this transaction.” If the caller chooses option 1, the system should obtain an authorization, following procedures described above. If approved, the system calls the FundCard service for the amount of load i.e. 50.00 (not including the convenience fee) and separately registers the fee. It reports, “Your Transaction was Successful.” Or, if the transaction was declined, it prompts, “Your transaction was declined by your credit card issuing bank, please choose another funding source.” If the caller chooses option 2, the system prompts: “You have cancelled this transaction”.

Optionally, the system can be configured to disable all live checking loads, requiring delayed loads.

The basic function for redeeming (withdrawal from card to ACH) of cards through IVR is driven off Option 5 to withdraw funds from a card. The submenu may prompt, “Press 1 to withdraw funds to your checking account. Press 2 to withdraw funds to your credit card.” If 1 is pressed, IVR checks to see which User that card is registered to. For example, if the user has inputted a PAN of xxxxxxxxxxxxx0007, then run the following SQL statement:

| | |
|---|---|
| SELECT | * |
| FROM | cards |
| WHERE | (panum = ‘xxxxxxxxxxxxx0007’) |

This will give you the “Master” User, which is the first to appear in the record set, if there are multiple results. The DB returns is:

| | |
|---|---|
| 27 | xxxxxxxxxxxxx0007 |
| 1352 | xxxxxxxxxxxxx0007 |
| 5184 | xxxxxxxxxxxxx0007 |
| 12599 | xxxxxxxxxxxxx0007 |

So the “Master” User is “27”. The system checks a user information table for a match for this User.

| | |
|---|---|
| SELECT | * |
| FROM | customerinformation |
| WHERE | (cust_id = ‘27’) |

If NO DATA from this query (empty record set) is returned prompt: “There are no checking accounts registered to this account,” and then returns to main menu. When there is data, the DB returns:

1 27 John Public 4464 John Ave. Las Vegas NV 89102
702-555-
1212 01/01/1975 111-22-3333 xxxxxx4514 NV johnq@isp.com
.....Personal USA web IP123.123.123.123 PR-00000005 Bank
of IPR
1125455547 015445547 0 1000

The typical elements needed for authorization of this checking account are present. For instance, the user; account and routing numbers; daily limit (which is the amount that can be funded PER DAY should be constrained to the value contained in the daily limit field. In this case, 1,000.00. In MOST cases the daily limit is 250.00; the exemplary limits has been raised to accommodate John Public's spending habits).

The IVR asks the caller which checking account to which they wish to transfers funds, identified by only use the last 4 or 5 digits. “Press 1 to withdraw funds to checking account number 5547 (five five four seven). (Press 2, Press 3, Etc. for more than one checking account).” Then, IVR will ask caller to enter the amount of funds to their card, “Enter the dollar amount you wish to withdraw . . . ” For instance, 50.00 is entered. The system computes the convenience fee for the charge. This fee may be coded so that it can easily be adjusted. For instance, a withdrawal fee of fee of 1.50. Total to charge: 51.50. It tells the user, “The total amount charged to your credit card will be Fifty One Dollars and Fifty Cents including the convenience fee, Press 1 to complete this transaction, press 2 to cancel this transaction.” If the caller chooses option 1, the system should obtain an authorization, following procedures described above. If approved, the system calls the RedeemCard service for the total amount of the withdrawal, 51.50 and credit via ACH the 50.00. It reports, “Your Transaction was Successful.” Or, if the transaction was declined for insufficient funds, it prompts, “Your transaction was declined by for insufficient funds, please chose another withdrawal source.” If the caller chooses option 2, the system prompts: “You have cancelled this transaction”.

Optionally, the system can be configured to disable all live checking withdrawals, requiring delayed withdrawals.

Some Particular Embodiments

The present invention may be practiced as a method or device adapted to practice the method. The same method can be viewed from the perspective of the system accepting requests or a network edge device that is making requests of the system. The invention may be an article of manufacture such as media impressed with logic to carry out a computer implemented method, such as a method of advancing value from a credit card account to a demand deposit account previously associated with the stored value card, a method of detecting a cash deposit and attributing the cash deposit to an account, a method of crediting a demand deposit account with value received at a retail point-of-sale terminal, or a method of fraud prevention and incremental commitment of value from a stored value card.

One embodiment is a computer implemented method of advancing value from a credit card account to demand deposit account previously associated with a stored value card. This method includes requesting a credit card transaction via an electronic message that specifies transfer of value from a consumer to a trusted transfer authority that automatically applies the value to a demand deposit account previously associated with the stored value card. The credit card transaction optionally can be specially-coded. The special coding may put the transaction on par with credit card cash advance transactions. The special coding may indicate that the transaction is subject to non-chargeback terms. This method further includes receiving authorization for the electronic credit card transaction, the authorization implying a promise to electronically settle the value into a settlement accounted designated by the trusted transfer authority. By the term “implying”, we mean to include invoking an agreement more fully set out elsewhere, such as in a cardholder agreement. We do not mean to exclude the case where agreement wording is part of the authorization message, but it is not expected that all of the terms of an agreement would be included with an authorization message or that an agreement could practically be tendered and formed for each credit card transaction authorization message, at least using existing technology for credit card approval. The trusted transfer authority automatically electronically advances funds into the demand deposit account upon receiving the authorization and updates the available balance of the demand deposit account. Electronic advancing and updating the available balance optionally may be performed substantially in real time. By the term “real time”, as quickly as the computer and network technology being used permits, without delay for human review in routine cases.

In addition to the steps above, the first embodiment may include the trusted authority, upon receiving an electronic request invoking the stored value card with an additional authentication factor, permitting redemption of as much of the electronically advanced funds is requested, without waiting for the electronic settlement of the credit card transaction. A further aspect of this embodiment may be use of a specially coded electronic credit card transaction that implies a guarantee to electronically settle the value without electronically revoking the settlement.

The method may include at least the trusted transfer authority collecting a fee from the consumer or at least the credit card processor collecting a fee from the consumer.

Electronically invoking the stored value card may alternatively involve a terminal electronically reading the stored value card or a user supplying an account number associated with the stored value card.

The additional authentication factor may be a PIN, a biometric measurement, fingerprint, or retinal scan. The request for the credit card transaction may be associated with an authentication factor received from the consumer.

The amount of value to be transferred may be selected by the consumer without restriction to pre-selected values. The electronic advance of funds, other than any transaction fee applicable, does not qualify as bookable revenue to the trusted transfer authority, because it is an advance rather than prepayment for a purchase.

A system embodiment corresponding to the first method embodiment may include bank core system interface including a transaction message interface and replicated data interface, a consumer facing appearance, a banking systems interface including an electronic credit card authorization interface and a consumer transaction processor. The consumer transaction processor includes logic and resources at least to load value automatically from a credit card to a stored value card and to redeem value from the stored value card. The consumer transaction processor further includes logic and resources to manage several interactions. The logic and resources are adapted to interact with the consumer through the consumer facing appearance to initiate an electronic credit card transaction to transfer value from the consumer for application automatically to a demand deposit account previously associated with the stored value card. It is further adapted to interact with the credit card authorization authority through the banking services interface to obtain authorization implying a promise to electronically settle a value into a settlement accounted designated by a trusted transfer authority. It also is adapted to interact with the bank through the bank core system interface to automatically electronically advance funds into the demand deposit account upon receiving the authorization and update the available balance of the demand deposit account.

The consumer transaction processor may further include logic and resources to interact with the consumer or a merchant to redeem as much of the electronically advanced funds as requested from the demand deposit account upon electronic invocation of the stored value card with an additional authentication factor, without waiting for the electronic settlement of the credit card transaction.

The system embodiment further may be adapted to electronically advance funds in real time, for instance in less than seven seconds or less than 300 ms.

Interactions of the consumer transaction processor through the various interfaces may further implement the optional method aspects of the first method embodiment.

Another embodiment is a method of detecting a cash deposit and attributing the cash deposit to an account. This method includes responding to request to deposit a certain sum of cash to an account selected by a depositor by instructing the depositor to make two or more cash deposits in specific amounts totaling the certain sum to account(s) not controlled by the depositor. The method further includes monitoring a transaction history to detect the specific amounts of the two or more cash deposits and attributing the certain sum to the account selected by the depositor after detecting the specific amounts in the transaction history.

An aspect of the second method embodiment is the use of a single account or two or more accounts to receive the deposits. The accounts receiving deposits may accept only cash, so that the transaction history reflects only cash deposits. The transaction history may be adapted for user to view with a browser, in which case screen scraping is applied. Or, the transaction history may be transmitted in a machine-to-machine format, such as XML, with field labels that can be parsed without scraping.

In cases of uncertainty, attribution of particular deposits may be resolved by electronically accessing and reviewing electronically imaged deposit slips.

The second method embodiment also may include generating specific amounts that are sufficiently unique to distinguish deposits of those amounts from other deposits, without need to electronically access imaged deposit slips. The individual deposit amounts may be locally unique to the accounts in which they are being deposited for a predetermined time, or until deposits in those amounts have been attributed. The individual deposit amounts may be reused after a predetermined time, after they have been attributed, or after a waiting time after they are attributed. Uniqueness may be assured by having several accounts available to receive deposits.

The second method embodiment may further include updating the available balance of the account selected by the depositor. It may yet further include interacting with depositor or merchant to redeem as much of the cash deposits as requested from the account selected by the depositor upon electronic invocation of the stored value card with an additional authentication factor, without waiting for transfer of the cash deposit from the account(s) not controlled by the depositor to the account selected by the depositor. For instance, the account(s) not controlled by the depositor may be in a first bank and the account selected by the depositor may be in a second bank, different from the first.

A system embodiment corresponding the second method embodiment may include a bank core system interface including a transaction message interface and a replicated data interface, a consumer facing appearance, a banking services interface including access to a trusted transfer authority's account deposit transaction history and a consumer transaction processor. The consumer transaction processor may include logic and resources at least to load value, automatically upon verifying two or more cash deposits to the trusted transfer authority's account, to a stored value card and to redeem value from the stored value card. The consumer transaction processor further may include logic and resources adapted to conduct several interactions. The logic and resources are adapted to interact with a depositor through the consumer facing appearance to set up a transfer of a certain sum to an account selected by the depositor by instructing the depositor to make two or more cash deposits in specific amounts totaling the certain sum to account(s) not controlled by the depositor. The logic and resources are further adapted to monitor through the banking services interface the transaction history to detect the specific amounts of the two or more deposits. It is yet further adapted to interact with the bank through the bank core system interface to electronically advance the certain sum to the account selected by the depositor after detecting the specific amounts in the transaction history and to update the available balance of the demand deposit account. The logic and resources also are adapted to interact with the depositor or merchant to redeem as much of the electronically advanced funds as requested from the direct deposit account upon electronic invocation of the stored value card with an additional authentication factor, without waiting for transfer of the cash deposits from the account(s) not controlled by the depositor to the account selected by the depositor.

Interactions of the consumer transaction processor through the various interfaces may further implement the optional method aspects of the second method embodiment.

A third method embodiment includes crediting a demand deposit account in real time with value received at a retail point-of-sale (POS) terminal. This method may include selecting at the retail POS terminal a credit-to-demand-deposit-account transaction and selecting a user account through which the value received will be credited to the demand deposit account. It further includes originating at the retail POS terminal an electronic message indicating that the value has been received and is guaranteed for settlement, the electronic message destined for a demand-deposit-account-authority that has committed to make the funds available in the demand deposit account automatically and in real time upon receipt of the electronic message.

A further aspect of this method includes deducting a fee from the value received to compensate the operator of the retail POS terminal, the demand-deposit-account-authority, or both. Another aspect involves how the transaction and account identification are received at the retail POS terminal. The transaction may be selected by entering an SKU code or scanning a hang tag including an SKU code. It may be manually keyed. The destination account number may be electronically read from a stored value card or may be provided by a user interacting with an operator or directly with the retail POS terminal.

A fourth method embodiment, related to the third, is a method of crediting a demand deposit account in real time with value received at a retail POS terminal. This method includes receiving from the retail POS terminal a credit-to-demand-deposit-account transaction request including the designation of a user account through which the value received will be credited to the demand deposit account and an electronic message indicating that the value was received at the retail POS terminal and is guaranteed for settlement. The method further includes a demand-deposit-account-authority, automatically and in real time, electronically advancing funds corresponding to the value received into the demand deposit account upon receiving the electronic message and updating the available balance of the demand deposit account. The method further includes the demand-deposit-account-authority redeeming as much of the electronically advanced funds as requested from the direct deposit account upon electronic invocation of the stored value card with an additional authentication factor, without waiting for electronic settlement of the credit-to-demand-deposit-account transaction.

All further aspects of the third method embodiment also may apply to the fourth method embodiment.

The fifth embodiment is a method of fraud prevention and incremental commitment of value from a stored value card. This method includes receiving an authorization request initiated by or on behalf of a cardholder to authorize a specific amount of value transfer from a stored value card to a specific vendor within a period of 24 hours or less. The method further includes verifying an available balance of the stored value card, placing a hold on the requested value for a period, adjusting the available balance, and approving the authorization request. Alternatively, funds may be actually transferred, subject to reimbursement at the expiration of the period. Disposition of the hold or transfer depends on whether a transfer request from the specific vendor is received within the period of time. Upon receiving a transfer request from the specific vendor within the period for substantially the specific amount (or less), the method further includes approving the transfer request, adjusting the available balance of the stored value card, and releasing the hold. Alternatively, after expiration of the period without receiving a transfer request from the specific for substantially the specific amount (or less), the method involves automatically releasing the hold and adjusting the available balance.

According to one aspect and the invention, the authorization request corresponds to an intended online purchase by the cardholder. Alternatively, the authorization request relates to a long-distance telephone call by the cardholder and the period of time corresponds to an increment of duration of the telephone call. The transfer request and the authorization request are periodically repeated as expiration of the increment approaches.

While the present invention is disclosed by reference to the preferred embodiments and examples detailed above, it is understood that these examples are intended in an illustrative rather than in a limiting sense. Computer-assisted processing is implicated in the described embodiments. It is contemplated that modifications and combinations will readily occur to those skilled in the art, which modifications and combinations will be within the spirit of the invention and the scope of the following claims.

We claim as follows:

1. A method of fraud prevention and incremental commitment of value from a stored value card, including:
receiving an authorization request initiated by or on behalf of a cardholder to authorize a specific amount of value transfer from a stored value card to a specific vendor within a period of 24 hours (or less);
verifying an available balance of the stored value card, placing a hold on the requested value for the period, adjusting the available balance, and approving the authorization request;
upon receiving a transfer request from the specific vendor within the period for substantially the specific amount (or less), approving the transfer request, adjusting the available balance of the stored value card, and releasing the hold; and
after expiration of the period without receiving a transfer request from the specific vendor for substantially the specific amount (or less), automatically releasing the hold and adjusting the available balance.

2. The method of claim 1, wherein the authorization request corresponds to an intended online purchase by the cardholder.

3. The method of claim 1, wherein
the authorization request relates to a long distance telephone call by the cardholder;
the period corresponds to an increment of the telephone call, and the transfer request and the authorization request are periodically repeated as expiration of the increment approaches.

4. The method of claim 1, wherein the period of minutes corresponds to an increment of the long distance phone call.
